(19) United States
(12) Patent Application Publication
(10) Pub. No.: US 2016/0111777 A1
(43) Pub. Date: Apr. 21, 2016

(54) MOBILE DEVICE

(71) Applicant: Acer Incorporated, New Taipei City (TW)

(72) Inventor: Chung-Wen YANG, New Taipei City (TW)

(21) Appl. No.: 14/614,433

(22) Filed: Feb. 5, 2015

(30) Foreign Application Priority Data
Oct. 15, 2014 (TW) 103135623

(51) Int. Cl. H01Q 1/52; H01Q 1/50; H01Q 9/04; H01Q 21/28

(52) U.S. Cl. CPC H01Q 1/521; H01Q 21/28; H01Q 1/50; H01Q 9/04

(57) ABSTRACT

A mobile device at least includes an antenna system. The antenna system includes a first antenna, a second antenna, a first isolation element, and a second isolation element. The first antenna is excited by a first signal source. The second antenna is excited by a second signal source. A first end of the first isolation element is coupled to a ground region, and a second end of the first isolation element is open. A first end of the second isolation element is coupled to the ground region, and a second end of the second isolation element is open. The first isolation element and the second isolation element are both disposed between the first antenna and the second antenna, and are configured to enhance the isolation of the antenna system.

### CROSS REFERENCE TO RELATED APPLICATIONS

This Application claims priority of Taiwan Patent Application No. 103135623 filed on Oct. 15, 2014, the entirety of which is incorporated by reference herein.

### BACKGROUND OF THE INVENTION

1. Field of the Invention

The disclosure generally relates to a mobile device, and more particularly, to a mobile device including an antenna system with high-isolation characteristics.

2. Description of the Related Art

With advancement in mobile communication technology, mobile devices such as portable computers, mobile phones, multimedia players, and other hybrid functional portable electronic devices have become more common To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

An antenna system is indispensable in a mobile device supporting wireless communication. However, since the interior space of a mobile device is very limited, multiple antennas are usually disposed close to each other, and such a design causes serious interference between antennas. As a result, there is a need to design a new antenna system for solving the problem of bad isolation in a conventional antenna system.

### BRIEF SUMMARY OF THE INVENTION

In a preferred embodiment, the invention is directed to a mobile device including an antenna system. The antenna system includes a first antenna, a second antenna, a first isolation element, and a second isolation element. The first antenna is excited by a first signal source. The second antenna is excited by a second signal source. A first end of the first isolation element is coupled to a ground region, and a second end of the first isolation element is open. A first end of the second isolation element is coupled to the ground region, and a second end of the second isolation element is open. The first isolation element and the second isolation element are both disposed between the first antenna and the second antenna, and are configured to enhance the isolation of the antenna system.

In some embodiments, the first isolation element and the second isolation element each substantially have an L-shape. In some embodiments, the first isolation element and the second isolation element each have a length which is substantially 0.25 wavelength of a central operation frequency of the antenna system. In some embodiments, the first antenna includes a first feeding element and a first radiation element, the first feeding element is coupled to the first signal source, a first end of the first radiation element is coupled to the ground region, a second end of the first radiation element is open and adjacent to the first feeding element, the second antenna includes a second feeding element and a second radiation element, the second feeding element is coupled to the second signal source, a first end of the second radiation element is coupled to the ground region, and a second end of the second radiation element is open and adjacent to the second feeding element. In some embodiments, the first radiation element and the second radiation element each substantially have an L-shape. In some embodiments, the first antenna further includes a first tuning element, the first tuning element is coupled to a turning point of the first radiation element, such that a combination of the first tuning element and the first radiation element substantially has a T-shape, and the second antenna further includes a second tuning element, the second tuning element is coupled to a turning point of the second radiation element, such that a combination of the second tuning element and the second radiation element substantially has a T-shape. In some embodiments, the second end of the first radiation element and the second end of the second radiation element extend away from each other. In some embodiments, the first antenna and the second antenna both operate in a first frequency band and a second frequency band, the first frequency band is substantially from 2400 MHz to 2500 MHz, and the second frequency band is substantially from 5150 MHz to 5850 MHz. In some embodiments, the mobile device further includes a display device, a system end, and a hinge. The system end includes a system end upper cover and a system end lower cover. The hinge is coupled between the display device and the system end. The antenna system is disposed adjacent to the hinge and substantially parallel to the system end upper cover. In some embodiments, the mobile device further includes an antenna support element and a hinge cover element. The antenna support element is disposed adjacent to the hinge. The antenna support element is configured to fix the antenna system. The hinge cover element covers the antenna support element and the antenna system. The antenna system is coupled to the system end upper cover or the system end lower cover.

### BRIEF DESCRIPTION OF DRAWINGS

The invention can be more fully understood by reading the subsequent detailed description and examples with references made to the accompanying drawings, wherein:

FIG. 1 is a diagram of a mobile device according to an embodiment of the invention;

FIG. 2 is a diagram of a mobile device according to an embodiment of the invention;

FIG. 3 is a diagram of a mobile device according to an embodiment of the invention;

FIG. 4 is a diagram of isolation of an antenna system of FIG. 2 when the antenna system is formed on a transformable notebook computer of FIG. 6, without a first isolation element and a second isolation element;

FIG. 5 is a diagram of isolation of an antenna system according to an embodiment of the invention;

FIG. 6 is a diagram of a mobile device according to an embodiment of the invention; and

FIG. 7 is a cross sectional view of a mobile device along a sectional line according to an embodiment of the invention.

### DETAILED DESCRIPTION OF THE INVENTION

In order to illustrate the foregoing and other purposes, features and advantages of the invention, the embodiments and figures of the invention will be described in detail as follows.

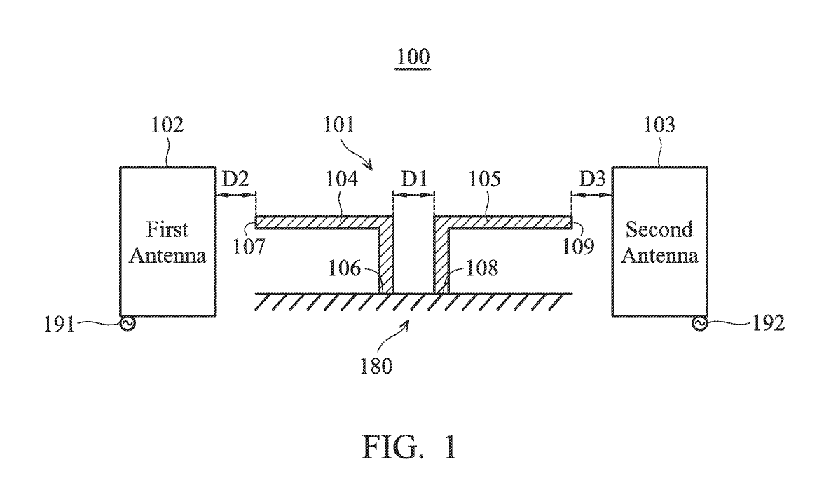

FIG. 1 is a diagram of a mobile device 100 according to an embodiment of the invention. The mobile device 100 may be a tablet computer, a notebook computer or a combination thereof. The mobile device 100 at least includes an antenna system 101. The antenna system 101 at least includes a first antenna 102, a second antenna 103, a first isolation element 104, and a second isolation element 105. The types of the first antenna 102 and the second antenna 103 are not limited in the invention. For example, any of the first antenna 102 and the second antenna 103 may be a coupling-feed antenna, a monopole antenna, a dipole antenna, a patch antenna, a loop antenna, or a helical antenna. The first antenna 102 is excited by a first signal source 191. The second antenna 103 is excited by a second signal source 192. The first signal source 191 and the second signal source 192 may be RF (Radio Frequency) modules of the mobile device 100. The first isolation element 104 and the second isolation element 105 are configured to increase the isolation (S21) between the first antenna 102 and the second antenna 103, such that the first antenna 102 and the second antenna 103 do not tend to interfere with each other. It should be understood that the mobile device 100 may further include other components, such as a display device, a processor, a battery, a touch control panel, a speaker, a system circuit board, and a housing (not shown).

The first isolation element 104 and the second isolation element 105 are both disposed between the first antenna 102 and the second antenna 103. The first isolation element 104 and the second isolation element 105 each have a length which is substantially 0.25 wavelength (λ/4) of a central operation frequency (e.g., 2400 MHz) of the antenna system 101. More particularly, a first end 106 of the first isolation element 104 is coupled to a ground region 180, a second end 107 of the first isolation element 104 is open, a first end 108 of the second isolation element 105 is coupled to the ground region 180, and a second end 109 of the second isolation element 105 is open. The second end 107 of the first isolation element 104 and the second end 109 of the second isolation element 105 extend in opposite directions and away from each other. The ground region 180 may be a metal ground plane of the mobile device 100, and it provides a ground voltage. In some embodiments, the first isolation element 104 and the second isolation element 105 each substantially have an L-shape. For example, the first isolation element 104 may include a first portion which is perpendicular to an edge of the ground region 180, and a second portion which is parallel to the edge of the ground region 180. The length of the aforementioned second portion may be longer than the length of the aforementioned first portion. Similarly, the second isolation element 105 may also include a first portion which is perpendicular to the edge of the ground region 180, and a second portion which is parallel to the edge of the ground region 180. The length of the aforementioned second portion may be longer than the length of the aforementioned first portion. The spacing D1 between the first isolation element 104 and the second isolation element 105 may be greater than 10 mm. The spacing D2 between the first isolation element 104 and the first antenna 102 may be greater than 10 mm. The spacing D3 between the second isolation element 105 and the second antenna 103 may be greater than 10 mm. After the first isolation element 104 and the second isolation element 105 are incorporated into the antenna system 101, it can directly suppress the electromagnetic interference between the first antenna 102 and the second antenna 103, thereby improving the isolation between the first antenna 102 and the second antenna 103. Conversely, the antenna system of a conventional design usually maintains the isolation by increasing the spacing between antennas. The invention proposes the use the first isolation element 104 and the second isolation element 105, instead of increasing the spacing between antennas, and it not only maintain the good performance of the antenna system 101, but also minimize the occupied inner space of the mobile device 100.

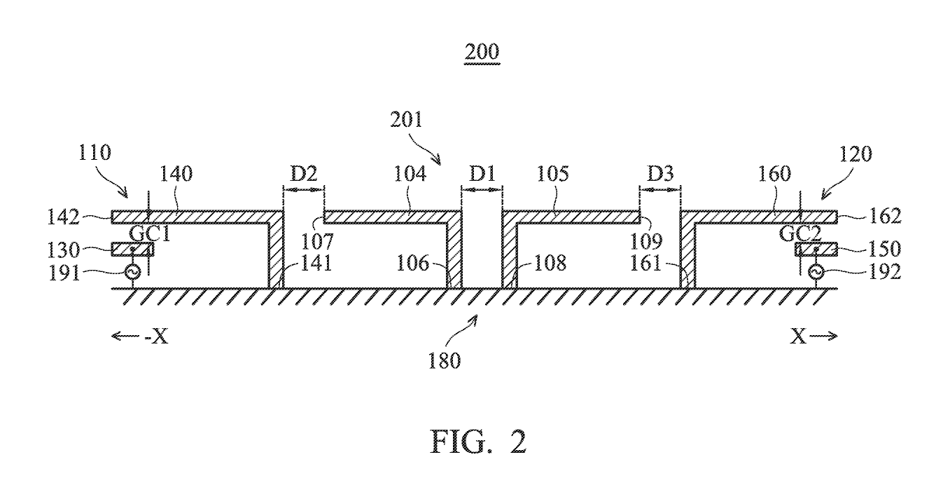

FIG. 2 is a diagram of a mobile device 200 according to an embodiment of the invention. FIG. 2 is similar to FIG. 1. In the embodiment of FIG. 2, the mobile device 200 at least includes an antenna system 201, and the antenna system 201 at least includes a first antenna 110, a second antenna 120, a first isolation element 104, and a second isolation element 105. The functions and structures of the first isolation element 104 and the second isolation element 105 have been described in the embodiments of FIG. 1. The first antenna 110 includes a first feeding element 130 and a first radiation element 140. The first feeding element 130 is coupled to a first signal source 191. The first feeding element 130 may substantially have a rectangular shape or a square shape. The first signal source 191 may be arranged for exciting the first antenna 110. The first radiation element 140 may substantially have an L-shape. A first end 141 of the first radiation element 140 is coupled to a ground region 180, and a second end 142 of the first radiation element 140 is open and adjacent to the first feeding element 130. A first coupling gap GC1 may be formed between the second end 142 of the first radiation element 140 and the first feeding element 130, and the width of the first coupling gap GC1 may be shorter than 2 mm. The second antenna 120 includes a second feeding element 150 and a second radiation element 160. The second feeding element 150 is coupled to a second signal source 192. The second feeding element 150 may substantially have a rectangular shape or a square shape. The second signal source 192 may be arranged for exciting the second antenna 120. The second radiation element 160 may substantially have an L-shape. A first end 161 of the second radiation element 160 is coupled to the ground region 180, and a second end 162 of the second radiation element 160 is open and adjacent to the second feeding element 150. A second coupling gap GC2 may be formed between the second end 162 of the second radiation element 160 and the second feeding element 150, and the width of the second coupling gap GC2 may be shorter than 2 mm. The second end 142 of the first radiation element 140 and the second end 162 of the second radiation element 160 may extend away from each other. For example, the second end 142 of the first radiation element 140 may extend toward the −X axis, and the second end 162 of the second radiation element 160 may extend toward the +X axis, such that they may extend away from each other. The first antenna 110 and the second antenna 120 of the antenna system 201 are both coupling-feed antennas. The first radiation element 140 is excited by the first feeding element 130 through mutual coupling, and the second radiation element 160 is excited by the second feeding element 150 through mutual coupling. The aforementioned coupling-feed antennas are configured to improve the isolation and SAR (Specific Absorption Rate) of the antenna system 201. More particularly, the first antenna 110 and the second antenna 120 both operate in a low-frequency band and a high-frequency band. For the first antenna 110, the high-frequency band is generated by exciting the first feeding element 130, and the low-frequency band is generated by exciting the first feeding element 130 and the first radiation element 140. For the second antenna 120, the high-frequency band is generated by exciting the second feeding element 150, and the low-frequency band is generated by exciting the second feeding element 150 and the second radiation element 160. For a conventional 2.4 GHz/5 GHz dual-band PIFA (Planar Inverted F Antenna), its low-frequency resonant paths may generate higher-order resonant modes and contribute to high-frequency currents, and therefore the high-frequency (5 GHz) SAR of the conventional PIFA may not meet the legal requirements. In the embodiment of FIG. 2, since the first feeding element 130 is separate from the first radiation element 140 and the second feeding element 150 is separate from the second radiation element 160, the low-frequency resonant paths do not tend to generate higher-order resonant modes which directly affect the antenna performance in the high-frequency band, and the high-frequency SAR of the antenna system 201 is greatly reduced accordingly. In addition, the first antenna 110 and the second antenna 120 extend in opposite directions, with their open ends away from each other, such that the isolation of the antenna system 201 is improved more. Other features of the mobile device 200 of FIG. 2 are similar to those of the mobile device 100 of FIG. 1. Accordingly, the two embodiments can achieve similar levels of performance

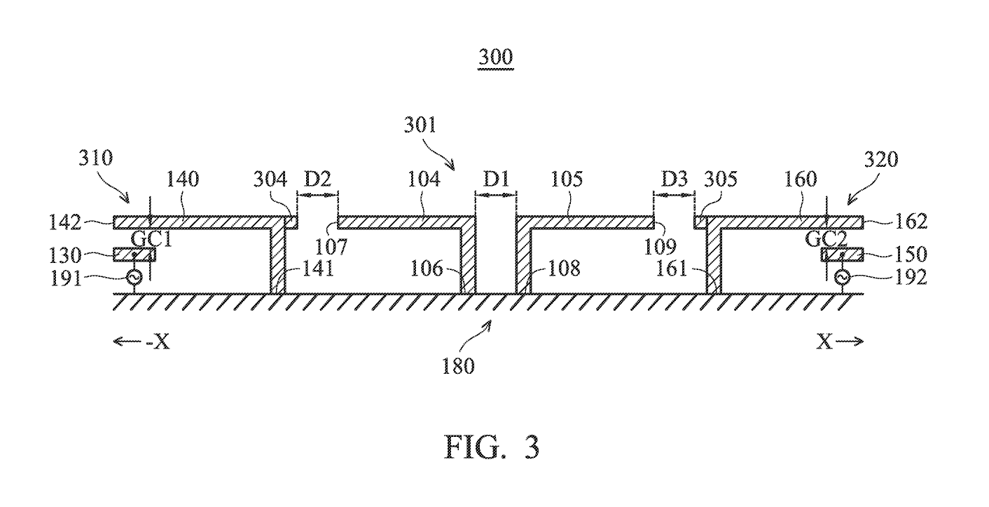

FIG. 3 is a diagram of a mobile device 300 according to an embodiment of the invention. FIG. 3 is similar to FIG. 2. In the embodiment of FIG. 3, the mobile device 300 at least includes an antenna system 301. A first antenna 310 of the antenna system 301 further includes a first tuning element 304. A second antenna 320 of the antenna system 301 further includes a second tuning element 305. In the first antenna 310, the first tuning element 304 is coupled to a turning point of a first radiation element 140, such that a combination of the first tuning element 304 and the first radiation element 140 substantially has a T-shape. The length of the first tuning element 304 is much shorter than the length of the first radiation element 140. In the second antenna 320, the second tuning element 305 is coupled to a turning point of a second radiation element 160, such that a combination of the second tuning element 305 and the second radiation element 160 substantially has a T-shape. The length of the second tuning element 305 is much shorter than the length of the second radiation element 160. The first tuning element 304 is configured to tune the impedance matching of the first antenna 310. The second tuning element 305 is configured to tune the impedance matching of the second antenna 320. Other features of the mobile device 300 of FIG. 3 are similar to those of the mobile device 200 of FIG. 2. Accordingly, the two embodiments can achieve similar levels of performance.

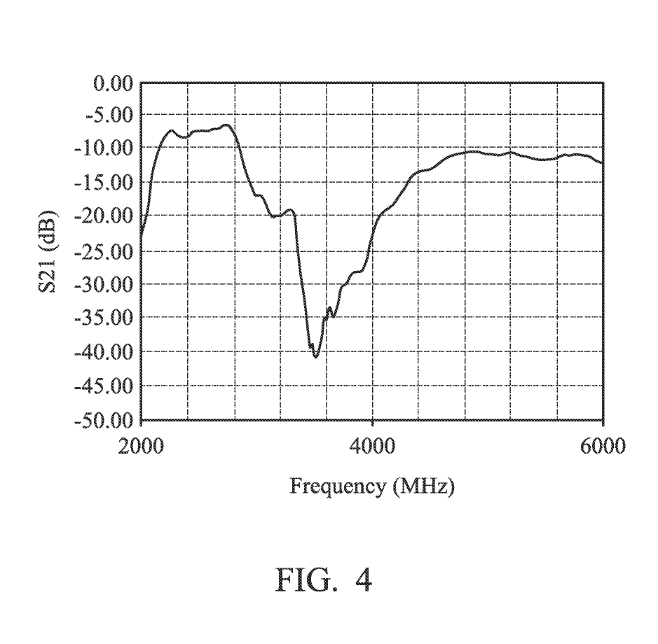

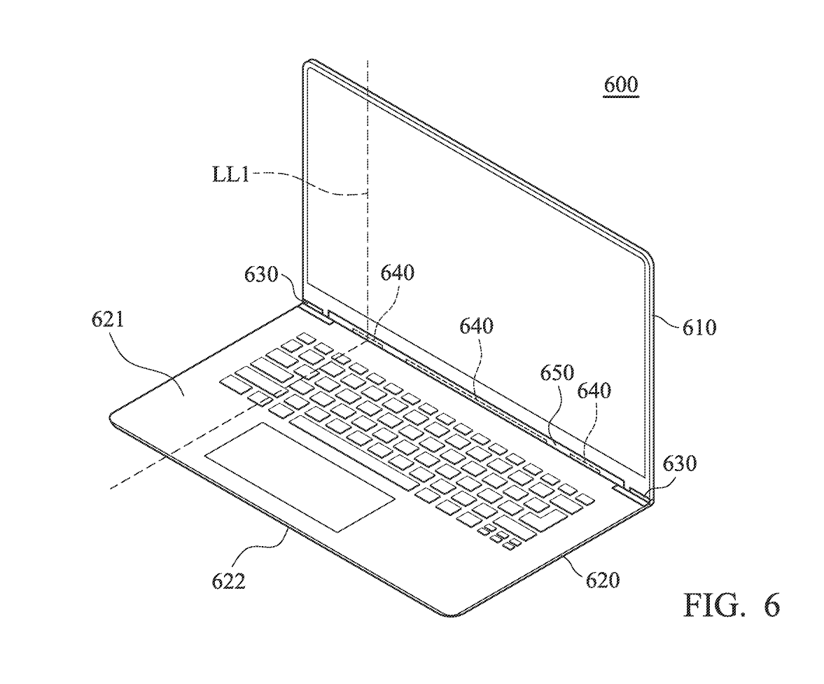

FIG. 4 is a diagram of the isolation of the antenna system of FIG. 2 when the antenna system is formed on a transformable notebook computer of FIG. 6, without the first isolation element 104 and the second isolation element 105. The horizontal axis represents the operating frequency (MHz), and the vertical axis represents the isolation (S21) (dB) between antennas. According to the measurement of FIG. 4, the isolation of the antenna system without any isolation element may be merely −7 dB in a low-frequency band, and it means that the interference between antennas is relatively serious and the quality of communication is degraded.

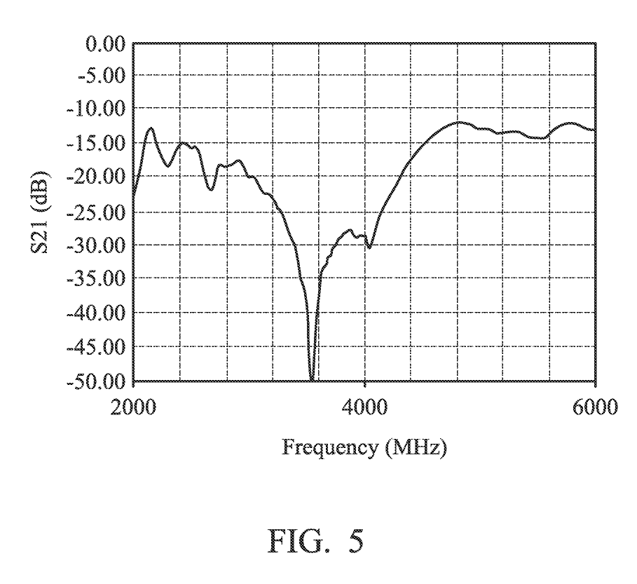

FIG. 5 is a diagram of the isolation of the antenna system according to an embodiment of the invention (e.g., the antenna system of FIG. 2 formed on the transformable notebook computer of FIG. 6). The horizontal axis represents the operating frequency (MHz), and the vertical axis represents the isolation (S21) (dB) between antennas. In the antenna system of the invention, the first antenna, the second antenna, the first isolation element, and the second isolation element all operate in a first frequency band and a second frequency band. The first frequency band may be substantially from 2400 MHz to 2500 MHz, and the second frequency band may be substantially from 5150 MHz to 5850 MHz. In other words, the invention at least supports the mobile communication frequency band of Wi-Fi and Bluetooth. According to the measurement of FIG. 5, when the antenna system uses the isolation elements described in the embodiments of FIGS. 1 to 3, the isolation between the antennas can achieve −15 dB or better in both the first frequency band and the second frequency band, and it can meet the criteria of general mobile communication. Furthermore, the design of coupling-feed antennas suppresses higher-order resonant modes of low-frequency resonant paths, such that the antenna system of the invention can easily meet the requirements of SAR in every frequency band. For example, the measured SAR may be as indicated in Table I.

TABLE I
Measured SAR (Antenna Gain = −2.95 dBi,
and RF output power = 16 dBm)

| | SAR measured | |
|---|---|---|
| | on the bottom | SAR measured on the top |
| Conventional PIFA | 1.92 | 1.81 |
| Proposed Antenna System | 1.85 | 0.99 |

Table I shows a comparison of measured SAR. According to the measurement, the invention has significantly lower SAR on the top and bottom than a conventional PIFA does when these antenna systems have the same antenna gain (e.g., the antenna gain is set to −2.95 dBi, and the RF output power is set to 16 dBm). More particularly, the proposed antenna system has SAR measured on the top which is almost 0.5 times that of the conventional design. As a result, the antenna system of the invention can help to meet the SAR criteria prescribed by law.

FIG. 6 is a diagram of a mobile device 600 according to an embodiment of the invention. In the embodiment of FIG. 6, the mobile device 600 may be a normal notebook computer or a transformable notebook computer. The transformable notebook computer may operate in a notebook mode or a tablet mode. The mobile device 600 at least includes a display device 610, a system end 620, and a hinge 630. The display device 610 may be an LCD (Liquid Crystal Display). The system end 620 includes a system end upper cover 621, a system end lower cover 622, and a host circuit board therebetween (not shown). The system end upper cover 621 and the system end lower cover 622 may be made of metal materials, and they are substantially parallel to each other. The hinge 630 is coupled between the display device 610 and the system end 620. By using the hinge 630, the mobile device 600 selectively operates in an open mode (e.g., the angle between the display device 610 and the system end 620 may be about 110 degrees) or a close mode (e.g., the angle between the display device 610 and the system end 620 may be about 5 degrees or less). An antenna system 640, as described in the embodiments of FIGS. 1-3, may be disposed adjacent to the hinge 630 and enclosed by a hinge cover element 650. The hinge cover element 650 may be made of nonconductive materials (e.g., plastic), and therefore it does not shield the radiation pattern of the antenna system 640.

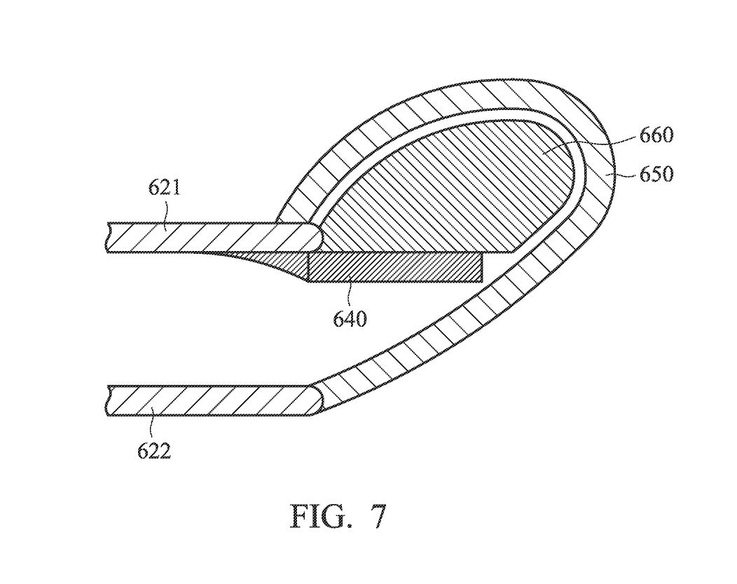

FIG. 7 is a cross sectional view of the mobile device 600 along a sectional line LL1 according to an embodiment of the invention. As shown in FIG. 7, the mobile device 600 may further include an antenna support element 660. The antenna support element 660 is disposed adjacent to the hinge 630, and is configured to fix the antenna system 640. For example, the antenna support element 660 may substantially have an irregular plastic cylinder, and the antenna system 640 may be fixed below an inner plane of the antenna support element 660. The hinge cover element 650 completely covers the antenna support element 660 and the antenna system 640, so as to maintain the consistency of appearance. With the antenna support element 660, the antenna system 640 may be substantially parallel to the system end upper cover 621. The antenna system 640 may be further coupled to the system end upper cover 621 or the system end lower cover 622, which may be used as an extension portion of a ground region of the antenna system 640. By disposing the antenna system 640 parallel to the system end upper cover 621 and adjacent to the hinge 630, it can ensure that the mobile device 600 has good quality of communication in both the open mode and the close mode, and the mobile device 600 can easily meet the criterion of SAR prescribed by law. Accordingly, the proposed antenna system of the invention can be integrated with a normal notebook computer or a transformable notebook computer, and significantly improve its performance of communication.

Note that the above element sizes, element shapes, and frequency ranges are not limitations of the invention. An antenna designer can fine-tune these settings or values according to different requirements. It should be understood that the mobile device and the antenna system of the invention are not limited to the configurations of FIGS. 1-7. The invention may merely include any one or more features of any one or more embodiments of FIGS. 1-7. In other words, not all of the features displayed in the figures should be implemented in the mobile device and the antenna system of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
an antenna system, comprising:
a first antenna, excited by a first signal source;
a second antenna, excited by a second signal source;
a first isolation element, wherein a first end of the first isolation element is coupled to a ground region, and a second end of the first isolation element is open; and
a second isolation element, wherein a first end of the second isolation element is coupled to the ground region, and a second end of the second isolation element is open;
wherein the first isolation element and the second isolation element are both disposed between the first antenna and the second antenna.

2. The mobile device as claimed in claim 1, wherein the first isolation element and the second isolation element each substantially have an L-shape.

3. The mobile device as claimed in claim 1, wherein the first isolation element and the second isolation element each have a length which is substantially 0.25 wavelength of a central operation frequency of the antenna system.

4. The mobile device as claimed in claim 1, wherein the first antenna comprises a first feeding element and a first radiation element, the first feeding element is coupled to the first signal source, a first end of the first radiation element is coupled to the ground region, a second end of the first radiation element is open and adjacent to the first feeding element, the second antenna comprises a second feeding element and a second radiation element, the second feeding element is coupled to the ground region, and a second end of the second radiation element is open and adjacent to the second feeding element.

5. The mobile device as claimed in claim 4, wherein the first radiation element and the second radiation element each substantially have an L-shape.

6. The mobile device as claimed in claim 5, wherein the first antenna further comprises a first tuning element, the first tuning element is coupled to a turning point of the first radiation element, such that a combination of the first tuning element and the first radiation element substantially has a T-shape, and the second antenna further comprises a second tuning element, the second tuning element is coupled to a turning point of the second radiation element, such that a combination of the second tuning element and the second radiation element substantially has a T-shape.

7. The mobile device as claimed in claim 4, wherein the second end of the first radiation element and the second end of the second radiation element extend away from each other.

8. The mobile device as claimed in claim 1, wherein the first antenna and the second antenna both operate in a first frequency band and a second frequency band, the first frequency band is substantially from 2400 MHz to 2500 MHz, and the second frequency band is substantially from 5150 MHz to 5850 MHz.

9. The mobile device as claimed in claim 1, further comprising:
a display device;
a system end, comprising a system end upper cover and a system end lower cover; and
a hinge, coupled between the display device and the system end;
wherein the antenna system is disposed adjacent to the hinge and substantially parallel to the system end upper cover.

10. The mobile device as claimed in claim 9, further comprising:
an antenna support element, disposed adjacent to the hinge, wherein the antenna support element is configured to fix the antenna system; and
a hinge cover element, covering the antenna support element and the antenna system;
wherein the antenna system is coupled to the system end upper cover or the system end lower cover.
